(19) United States
(12) Patent Application Publication
(10) Pub. No.: US 2014/0274002 A1
(43) Pub. Date: Sep. 18, 2014

(54) ENHANCED CALLER IDENTIFICATION

(71) Applicants: Patrick James Hogan, San Francisco, CA (US); Blake Andrew Robertson, Baltimore, CA (US)

(72) Inventors: Patrick James Hogan, San Francisco, CA (US); Blake Andrew Robertson, Baltimore, CA (US)

(21) Appl. No.: 14/214,626

(22) Filed: Mar. 14, 2014

Related U.S. Application Data
(60) Provisional application No. 61/789,560, filed on Mar. 15, 2013.

(51) Int. Cl. H04W 4/12

(52) U.S. Cl. CPC H04W 4/12
USPC 455/415

(57) ABSTRACT

Systems and methods for enhanced caller identification are disclosed. In some embodiments, an incoming phone call may be received and a phone number of the incoming phone call may be identified. A query of an external database may be performed based on the phone number and information from an entry of the database that matches the phone number may be retrieved. A plurality of additional external databases may also be queried based on the phone number of information retrieved from another database that was queried based on the phone number. The information may be displayed in response to the incoming phone call and in response to an answering of the phone call. In some embodiments, the information may be displayed by way of a notification on a mobile phone.

### RELATED APPLICATION

This application claims priority under 35 U.S.C. §119(e) to U.S. Provisional Patent Application 61/789,560 filed on Mar. 15, 2013 and entitled “Systems and Methods for Enhanced Caller Identification,” which is hereby incorporated by reference in its entirety and for all purposes.

### FIELD

The present disclosure relates to telecommunications. In some embodiments, the present disclosure relates to enhanced caller identification.

### BACKGROUND

Conventional caller identification (caller ID) systems and methods typically display information to identify a caller making an incoming call. For example, certain conventional caller ID systems may display a name registered with a phone number that is currently calling a landline phone. Additional conventional caller ID systems and methods have been implemented with respect to mobile phones. For example, when a mobile phone (e.g., a smart phone) receives an incoming phone call, the mobile phone may identify the caller of the incoming phone call as well as display a photo locally stored on the mobile phone that is associated with the caller. Furthermore, the conventional caller ID systems and methods for mobile phones may also display information provided by a cellular network such as the caller's city, state, and/or country.

However, such conventional caller ID systems and methods are limited in the amount and type of information that may be presented to the user of a mobile phone in response to an incoming phone call. As such, it is desirable to develop systems and methods for enhanced caller identification. For example, such systems and methods may be applied to mobile phone technology to provide additional information with respect to an incoming phone call.

### SUMMARY

The present disclosure introduces systems and methods for enhanced caller identification.

In some embodiments, caller information may be displayed. An incoming phone call may be received and a phone number associated with the incoming phone call may be identified. A database may be searched based on the phone number. Information associated with the phone number may be received from the database and a notification comprising the information may be displayed in response to the incoming phone call.

In some embodiments, the database is an external database comprising at least one of a CRM system, social network, or an exchange server.

In some embodiments, the searching is performed by a computing device transmitting a search query to the database over a wireless network.

In some embodiments, the notification comprises notes taken by the user of the computing device and a previous email sent by a caller of the incoming phone call to the user of the computing device.

In some embodiments, the notification comprises an option to launch an application to display additional information associated with a caller of the incoming phone call.

In some embodiments, the computing device is a mobile phone and the application is a mobile application.

In some embodiments, a second database may be searched based on the identified phone number and the displayed notification comprises information from the first database and the second database.

### BRIEF DESCRIPTION OF THE DRAWINGS

The novel features of the disclosure are set forth in the appended claims. However, for purpose of explanation, several embodiments of the disclosure are set forth in the following figures.

FIG. 1 is a flow diagram of an example method to display a notification in response to an incoming phone call in accordance with some embodiments. This flow includes an example method to display a notification comprising an option to launch an application in accordance with some embodiments of the disclosure.

FIG. 2 is a diagram illustrating an example graphical user interface (GUI) with a notification in accordance with some embodiments.

FIG. 3 is a diagram illustrating an example GUI with another notification in accordance with some embodiments.

FIG. 4 is a diagram illustrating an example GUI of an application launched from a notification in accordance with some embodiments of the disclosure.

FIG. 5 is a diagram illustrating a display of a computing device presenting an example graphical user interface at various steps associated with an incoming phone call.

FIG. 6 is an example environment for a system and method for enhanced caller identification in accordance with some embodiments.

FIG. 7 is an additional example environment for a system and method for enhanced caller identification in accordance with some embodiments.

FIG. 8 is an additional example environment for a system and method for enhanced caller identification in accordance with some embodiments.

FIG. 9 is a flow diagram of an example method showing the interaction of various components of the disclosure in accordance with some embodiments.

FIG. 10 is an example environment of an enhanced intra-company caller ID in accordance with some embodiments.

FIG. 11 is a flow diagram of an example method utilizing a local contacts database in accordance with some embodiments.

FIG. 12 is a flow diagram of an example method to initiate an outbound phone call in accordance with some embodiments.

FIG. 13 depicts a diagram illustrating an exemplary computing system for execution of the operations comprising various embodiments of the disclosure.

### DETAILED DESCRIPTION

The systems and methods disclosed herein relate to enhanced caller identification.

In the following detailed description, numerous specific details are set forth in order to provide a thorough understanding of the present disclosure. However, it will become obvious to those skilled in the art that the present disclosure may be practiced without these specific details. The description and representation herein are the common means used by those experienced or skilled in the art to most effectively convey the substance of their work to others skilled in the art. In other instances, well known methods, procedures, and systems have not been described in detail to avoid unnecessarily obscuring aspects of the present disclosure.

FIG. 1 is a flow diagram of an example method to display a notification in response to an incoming phone call. In general, the example method may identify a caller of an incoming phone call, retrieve information associated with the caller, and display a notification comprising information. In some embodiments, a computing device may perform the method of FIG. 1. For example, a mobile phone (e.g., a cell phone, a smart phone, etc.) may perform the steps as disclosed with regard to FIG. 1. In some embodiments, software components or modules or hardware components of the computing device or mobile phone may perform the steps of the methods as disclosed herein.

As shown in FIG. 1, the method may receive, at step 100, an incoming phone call. For example, a phone system monitor component or module may detect the incoming phone call. In some embodiments, a computing device may have phone functionality and identify that an incoming phone call from a caller is being received. In the same or alternative embodiments, the phone system monitor may receive or identify the phone number of the incoming phone call and look up specific computing device details such as a computing device identification number, operating system of the computing device, etc. In some embodiments, the computing device identification number is a unique identifier of a mobile phone. At step 104, a phone system monitor may detect a new call and a backend information processor may search for a contact match associated with the call. At step 106, a determination may be made as to whether a match was found. If no match is found, then public data sources may be searched for contact information at step 107 and at step 108 a notification payload that indicates the contact is not in the database may be sent. Furthermore, a notification may be displayed on the phone at step 108 and at step 112 a user may launch an application. Furthermore, at step 114, a new contact may be created and at step 116 a user may enter contact information and/or call notes. At step 118, information may be sent to the backend information processor and at step 120 a contact may be created in the database. However, if the determination at step 106 is that there is one match, then at step 122, an intelligence algorithm may determine the most relevant information to display. At step 124, a notification payload with a single contact information is sent to the phone and at step 110 the notification may be displayed on the phone. Furthermore, the user may launch the application at step 112 and at step 130 additional details may be retrieved. Returning to step 106, if multiple matches are found, then at step 142, the intelligence algorithm may determine the most likely candidate match. Furthermore, at step 144, the notification payload indicating multiple matches may be sent to the phone and at step 110 the notification may be displayed on the phone. Again, the user may launch the application at step 112 and additional details may be received for each contact at step 146. At step 148, a selection of which contact to display may be received and at step 150 the user may select which matching contact and at step 152 the contact ID may be sent to backend information processor. At step 132, contact display may be performed. At step 134, a user may add a call note and at step 136 the note may be sent to backend and stored in a database. At step 138, a user may launch a third party application and at step 140 the appropriate mobile application or website may be opened directly to contact record.

In some embodiments, method may perform a contact match in response to the incoming phone call. A backend information processor component or module may receive a payload (e.g., data comprising the phone number of the incoming phone call, computing device identification number, operating system of the computing device, etc.) from the phone system monitor and perform a search for a contact match based on the payload. For example, the phone number of the incoming call may be identified and one or more databases or sources may be searched or queried based on the phone number of the incoming call. In some embodiments, the one or more databases or sources may be disparate databases or sources associated with one or more locations and types of information. Examples of such databases or sources include, but are not limited to, customer relationship management (CRM) systems, any type of database that stores contacts for a business, an exchange server (e.g., Microsoft Exchange Server), corporate directories, social networking sites, Calling Name (CNAM) databases, Yellow Pages, search engine searches, etc.

As such, the databases or sources may comprise various types of information located at different locations or sites. In some embodiments, the databases or sources may be selected to be searched based on a user input (e.g., the user of the computing device has indicated to search specific databases or sources in response to incoming phone calls).

In some embodiments, certain databases or sources may only allow querying or searching based on an email address, username, or other such information that is not a phone number. Since the backend information processor may initially receive the phone number of the incoming phone call from the phone system monitor, the backend information processor may first query databases or sources that may be queried or searched based on a phone number, identify an entry that matches the phone number, and identify an email address in the entry that matches the phone number. As such, the backend information processor may subsequently search another database or source with the email address in the entry that matches the phone number of the incoming phone call. For example, if a phone number 867-5309 is identified from an incoming phone call, then the backend information processor may search a first database based on the phone number and find a matching entry. A data field associated with the matching entry may comprise an email address of jenny@gmail.com. Next, the backend information processor may use the email address of jenny@gmail.com to search a second database (e.g., a database that is not searchable by phone number) based on this email address. As such, the backend information processor may perform a plurality of queries, where a first query on a first database may be based on the phone number of the incoming phone call and a second query on a second database may be based on an email address or other piece of information from a matching entry of the first database with the phone number.

Furthermore, a determination may be made as to whether a match has been found for the phone number of the incoming phone call in the database or source. Three possible outcomes may be determined including, but not limited to, no match being found, one match being found, and multiple matches being found. Details of the method following each of these possible outcomes are shown in detail in FIG. 1. If the phone number of the incoming phone call matches at least one entry associated with a database or source, then an intelligent computer algorithm may be used to determine relevant information from the database or source. For example, an algorithm associated with the backend information processor may transmit the information from the databases or sources that match the phone number or other data (e.g., the email address as previously discussed) to a relevance filter component or module. The relevance filter may filter through the information from the databases or sources and return the most relevant information or information that a user has earlier indicated as a user preference or based on user behavior. As such, the relevance filter may select a subset of the information from matching entries of the databases or sources that meet predefined criteria set by the user.

In some embodiments, a notification payload may be prepared based on the relevant information from the database or source and may be transmitted for display on the computing device. As such, the notification payload may comprise relevant information of a caller of the incoming phone call. However, if the determination from step 106 results in no match for the phone number of the incoming phone call in the database or source, then the notification payload may indicate that the identity of the caller of the incoming phone call is unknown and such information may be transmitted for display on the computing device or additional steps as shown in FIG. 1 may be performed. Furthermore, if the determination from step 106 results in a plurality of matches from one or more databases or sources, then alternative steps as shown in FIG. 1 may be performed. For example, one of the matches (e.g., contacts) from the one or more databases may be selected. A notification may be displayed on the computing device. For example, a notification may be displayed on a mobile device or smart phone. The notification may comprise information from the database or source if the phone number of the incoming phone call has matched at least one contact in the database or source and meets the criteria or conditions of the relevance filter.

As such, an incoming phone call may be received and a phone number of the incoming phone call may be identified by a mobile phone or a remote server. One or more databases or sources external to the mobile phone may be queried based on the identified phone number. Furthermore, data from entries of the databases or sources that match the identified phone number may be received and used as part of a query for other databases or sources. The information from the databases or sources may be sorted or filtered by a relevance filter to determine particular information that is to be transmitted to the mobile phone to be displayed to a user in a notification.

As such, a notification may be displayed on a computing device. For example, a notification as disclosed with regard to FIG. 1 may be displayed on a mobile phone and enable a user of the mobile phone to launch an application.

As shown in FIG. 2, a notification may be displayed on a computing device. For example, a notification may be displayed on a mobile phone. In some embodiments, a notification handler component or module may receive a payload (as previously disclosed with regard to FIG. 1) and look up special handling instructions based on the device identifier that is comprised within the payload.

For example, if the unique identifier identified the mobile phone as an Apple iPhone the notification handler component would understand that the iPhone has “Alert” notifications and “Banner” notifications. The notification handler would also be passed details in the payload about what type of notifications were enabled on that particular model of phone or what notifications were disabled by the user. Alert notifications appear at the center of the screen and do not hide themselves unless closed by the user. Banner notifications appear at the top of the screen and hide themselves after a set period of time, typically a few seconds.

Banner notifications can be problematic for being used as caller identification, because the typical time per ring is 4-6 seconds. Most people do not pickup their phones until the 2^{nd} or 3^{rd} ring. If a banner notification is enabled, it may be hidden by the time the user retrieves the mobile phone from their pocket. However, by default iPhone sets banner notifications unless a user specifically configures the application to allow alert notifications. The notification handler component would read the payload to see what type of notification was enabled. If Banner notifications were enabled the notification handler would send several successive banner notifications to enable constant viewing of the notification as the user is deciding whether to pickup the call.

Or in another example, if the unique identifier identified the mobile phone as an Android device, the notification handler component would understand that Android has “Normal View” and “Big View” notifications. Big View notifications would be a preferred method of sending the notification, because they allow for the display of more information. However, Big View notifications were not enabled in devices until Android OS 4.1. As of this writing only 16.5% of Android OS devices fit into this category, meaning that if a Big View notification would fail on an older device. The notification handler component would understand this and send the appropriate notification. Further, Android, similar to apple has restrictions on how long a notification will display in the Status Bar. The notification handler would send tightly timed status notifications and updates to allow for constant display.

The payload may then be wrapped inside of a notification wrapper

When sending a notification to a mobile device, the message may only be one component. Other pieces of information must be sent along with the message and wrapped together into one payload. These pieces of information include, but are not limited to device token, alias, badge, sound notification, and syntax formatting characters depending on the device.

In some embodiments, an application may be launched from a displayed notification. For example, the displayed notification may comprise an option to launch an application that may display additional information associated with the caller of the incoming phone call. For example contact information may be displayed and a user may select an option to launch an external application. For example, the notification may comprise an option to launch the external application to display more detailed information associated with the caller of the incoming phone call. In some embodiments, the external application may be another application (e.g., a mobile application) or a website. Furthermore, a user may add a call note for the caller of the incoming phone call and the note may be transmitted to the backend information processor and stored in a database.

FIG. 2 is a diagram illustrating an example graphical user interface (GUI) with a notification. In some embodiments, the GUI of FIG. 2 may overlay a notification on top of incoming phone call information. A notification (e.g., a push notification) may be displayed in response to an incoming phone call. For example, the information displayed in the notification may be associated with the phone number of the incoming phone call, obtained from one or more databases or sources, and filtered by a relevance filter as previously disclosed. In the example of FIG. 2, the notification comprises the name, position title, associated corporation, team role, notes composed by the user of the computing device for this contact (e.g., from an earlier time period), and an excerpt from an email from the caller of the incoming phone call. For example, in response to the incoming phone call, a plurality of database or sources may have been queried based on the phone number of the incoming phone call. A first database (e.g., a CRM) comprising the name, position title, corporation, and team role may be queried and relevant information extracted. A second database comprising notes associated with contacts may be queried based on the phone number and relevant notes may be extracted. Furthermore, a third database comprising emails may be searched and relevant emails may be extracted. The information from the plurality of databases may be filtered and then aggregated for display in the notification.

FIG. 3 is a diagram illustrating an example GUI with another notification. In this example, information from the databases or sources may be presented at the top of the GUI in the form of a bar. For example, information associated with the caller of the incoming phone call may be presented in the bar. On an Android device this is called a “Status Bar Notification” and on the iPhone this is called a Banner notification.

FIG. 4 is a diagram illustrating an example GUI of an application launched from a notification. In general, the GUI of FIG. 4 may be launched from a notification that has been displayed on the computing device (e.g., a mobile phone). As shown, the GUI may display the name, position, affiliated company, and additional information of the caller of the incoming phone call. For example, an average spending budget, personal information, notes, and emails (e.g., an excerpt or full portion of the last email sent to the user of the computing device from the caller of the incoming phone call) may be displayed. Furthermore, the GUI may also display a log notes field that may be used to input notes about the caller or phone call currently taking place on the computing device.

FIG. 5 is a diagram illustrating a display of a computing device presenting an example graphical user interface at various steps. As shown, an incoming phone call may first be received by the computing device or mobile phone. In response to the incoming phone call, the computing device may display a standard GUI alerting the user of the incoming phone call. Next, at step 2, a notification (e.g., a push notification) may be displayed over the standard GUI. At step 3, the incoming phone call may be answered and in response to the answering of the phone call, a second notification may be displayed. In some embodiments, the second notification may comprise an option to launch an application comprising additional information (e.g., from the database or sources) associated with the caller of the incoming phone call. If the application is launched, then the log notes GUI may be displayed, as shown at step 4.

As such, a computing device may display a first graphical user interface to alert a user of an incoming phone call. The first graphical user interface may display conventional information such as the phone number and a picture (if available) of the caller. Next, a first notification may be displayed on top of the first graphical user interface in response to the incoming phone call. The first notification may display information associated with the caller from one or more databases or sources as previously disclosed. In some embodiments, if the user of the computing device answers the incoming phone call, then a second notification may be displayed. The second notification may comprise similar information associated with the caller as the first notification. However, the second notification may also comprise an option to launch an application to display additional information associated with the caller and to log notes for the caller.

FIG. 6 is an example environment for a system and method for expanded caller identification in accordance with some embodiments. In the example environment of FIG. 6, the phone system monitor may be locally installed (e.g., on the computing device) and performs the identification of the phone number of the incoming phone call. As such, the computing device may perform these steps as opposed to an external server. In some embodiments, once the phone number is identified, it may be transmitted (e.g., over a wireless network) to the backend information processor to retrieve information associated with the caller from one or more databases or sources. The notification handler, located on the notification handler server may then generate the notification for the device. FIG. 7 is an additional example environment for a system and method for expanded caller identification. In this example environment, the phone system monitor may be placed such that it is between the incoming phone call and the computing device. As such, the phone system monitor may receive the incoming phone call. For example, the phone system monitor may receive the call through a user's private branch exchange (PBX) at work and it may be forwarded to the computing device. Once the phone number is identified, the phone number may be transmitted over a wireless network to the backend information processor to retrieve information associated with the caller of the incoming phone call. Subsequently, the notification handler server may generate the notification on the computing device. FIG. 8 is an additional example environment for a system and method for expanded caller identification. The example environment of FIG. 8 may comprise the phone system monitor locally installed on the computing device and it may perform the identification of the phone number of the incoming phone call. The phone number may be transmitted over a network to the backend information processor and the notification handler may generate the notification on the computing device.

FIG. 9 is a flow diagram of an example method showing the interaction of various components of the disclosure in accordance with some embodiments. In general, the various components or modules comprise a phone system monitor, backend information processor, relevance filter, notification handler, and a mobile application.

In some embodiments, the phone system monitor may monitor or observe the computing device (e.g., mobile phone) for events such as in incoming phone call or an outgoing phone call. The phone system monitor may detect when a phone call is made or received and may transmit the phone number (e.g., the incoming phone number or outgoing phone number) and device information to the backend information processor.

The backend information processor may receive the phone number of the incoming or outgoing phone call and the computing device information from the phone system monitor. When this information is received, the backend information processor may look up (e.g., query) data sources selected by the user based on the incoming phone number. The databases or data sources may then be queried based on the phone number received from the phone system monitor. Information returned from the database or sources may then be included in a payload and transmitted to the relevance filter. The data may then be returned from the relevance filter to the backend information processor, where the returned data may be formatted and transmitted to the notification handler.

In some embodiments, the relevance filter may be responsible for filtering the data received from the backend information processor into useful information based on the computing device identifier. The received data may processed through an algorithm that is based on, but not limited to, type of user (e.g., Sales Person, IT Person, Doctor, Lawyer), the amount of times the computing device identifier (and as such the user of the computing device) has communicated with the caller (e.g., new lead vs. existing customer), the recency of communications between the user of the computing device and the caller (e.g., communicated 1 day ago vs. 1 year ago), the priority level associated with the caller, etc. The filtered relevant data may then be transmitted to the backend information processor.

The notification handler may transmit the notification and handle complex timing aspects of keeping the notification in constant display on the computing device. For example, each type of mobile device presents unique challenges and restrictions for the display of notifications. The notification handler recognizes the type of mobile device operating system (e.g., Android™ or iOS™) and may transmit the notification with specialized timing and/or instructions for each mobile device based on its mobile device operating system.

Timing

An objective for the notification is for the notification to be displayed at the same time as the user of the mobile phone is making the decision to answer or decline the incoming phone call. Another objective is to have the notification displayed as the phone call is ongoing in order to give the user additional information about the caller they are speaking with and to allow for the launching of the mobile application. In some embodiments, the operating system of the computing device (e.g., a mobile device operating system) may place restrictions on actions that a third party application (e.g., the notification handler or other components or modules disclosed herein) may take within the operating environment while a phone call is being received or placed at the computing device. For example, on an iOS™ platform, if a notification is received within moments of a mobile phone receiving an incoming phone call, then the notification may be hidden from the user of the mobile phone by the overlay of the phone call itself (e.g., an indication of the incoming phone call). Because of such restrictions, it may be necessary for the notification handler to queue the notification and wait to display the notification until after the indication of the incoming phone call is displayed. As such, the notification comprising information from one or more databases or sources and associated with the caller of the incoming phone call may be sent after the operating system has displayed an indication of the incoming phone call. In some embodiments, this may be accomplished based on sensing or detecting the incoming phone call prior to the computing device or mobile phone itself receiving the incoming phone call. As such, advanced timing of notifications may be used to provide enhanced caller identification. This requires advanced timing of notifications to enhance user interaction. In other embodiments, the notification handler will only sense the call as it is coming in. While each platform has its differences, most platforms provide for some type of telephony status (e.g., “CALL_STATE_IDLE”, “CALL_STATE_OFFHOOK”, “CALL_STATE_RINGING”). The notification handler will display the notification in an order consistent with constant display on the platform depending on ring state.

Furthermore, the notification handler may also detect or identify when the incoming phone call is answered at the computing device or mobile phone. In some embodiments, answering an incoming phone call on a mobile phone may disable the notification as a new screen is displayed in response to a user of the mobile phone answering the incoming phone call. Such a restriction may require the notification handler to detect or identify the incoming phone call being answered and transmit a new notification that will be displayed over the display that the operating system itself presents in response to the answering of the incoming phone call. This new notification may allow the user to launch an application (e.g., a mobile application) to save notes associated with the caller or answered phone call.

Further operating system restrictions may be recognized when a computing device or mobile phone is in a lock position or when the local position turns on automatically due to period of user inactivity. In some embodiments, the lock position may be a function that disables at least some functionality of the computing device. For example, the lock position may disable inputs or input keys of a mobile phone such that a user of the mobile phone may place the mobile phone in his or her pocket or amongst items without having an accidental user input set off a series of actions on the mobile phone (e.g., pocket dialing of someone by accident, accidentally answering an incoming phone call, etc.). In some embodiments, an operating system of a mobile phone may display a lock screen when the mobile phone is in the lock position. The display of the lock screen may potentially cause a series of problems for providing enhanced caller identification. For example, on certain operating systems, a user may see the notification, however, he or she may not be able to click on the notification (e.g., to launch an application) while the mobile phone is in the lock position or mode. In alternative embodiments, a user may be limited to a notification that displays a much smaller amount of information than it would if the mobile phone was unlocked (e.g., not in the lock position or mode). In some embodiments, the notification handler may momentarily disable the lock position or mode of the mobile phone so that a user may be allowed to see a notification transmitted by the notification handler. For example, a user may place his or her mobile phone in a lock position. The locked mobile phone may receive an incoming phone call. Information associated with the caller of the incoming phone call and from one or more databases or sources may be identified based on the systems and methods previously disclosed. The notification handler may disable the lock position for the mobile phone, transmit the notification to be displayed on the display of the now unlocked mobile phone, and then quickly lock the mobile phone after the notification has been displayed. As such, the notification handler may unlock and re-lock a mobile phone based on a transmission of a notification to be displayed. In alternative embodiments, where the notification handler may not be able to unlock a mobile phone from a lock position, the notification may be displayed on the mobile phone and then re-displayed once the mobile phone is unlocked. Such an action may allow a more constant display of the notification to a user of the mobile phone and prevents the notification from being hidden by the phone being in the lock position. In alternative embodiments, a solution to the lock screen restriction as previously disclosed is to set up a phone system such that a user will need to confirm that he or she wants to answer a phone receiving an incoming phone call by pressing a button or key (e.g., a ‘1’) before accepting to answer the incoming phone call. Such a set up may allow the notification comprising the information associated with the caller of the incoming call information to appear prior to the user of the phone actually engaging in a conversation with the caller.

In some embodiments, each computing device may be associated with an application. For example, a mobile device may have an installed mobile application that is responsible for displaying the incoming phone call information once the application is loaded or before the application is loaded on mobile devices where each application is responsible for the display of the notification. The mobile application may also responsible for receiving user input. The mobile application may further provide the mechanism for the user to log notes and transmits these notes to a central customer database.

### Special Display Instructions

As previously disclosed, special display instructions may be used. For example, if the unique identifier identified the mobile phone as an Apple iPhone the notification handler component would understand that the iPhone has “Alert” notifications and “Banner” notifications. The notification handler would also be passed details in the payload about what type of notifications were enabled on that particular model of phone or what notifications were disabled by the user. Alert notifications appear at the center of the screen and do not hide themselves unless closed by the user. Banner notifications appear at the top of the screen and hide themselves after a set period of time, typically a few seconds.

Banner notifications can be problematic for being used as caller identification, because the typical time per ring is 4-6 seconds. Most people do not pickup their phones until the 2^{nd} or 3^{rd} ring. If a banner notification is enabled, it may be hidden by the time the user retrieves the mobile phone from their pocket. However, by default iPhone sets banner notifications unless a user specifically configures the application to allow alert notifications. The notification handler component would read the payload to see what type of notification was enabled. If Banner notifications were enabled the notification handler would send several successive banner notifications to enable constant viewing of the notification as the user is deciding whether to pickup the call.

Or in another example, if the unique identifier identified the mobile phone as an Android device, the notification handler component would understand that Android has “Normal View” and “Big View” notifications. Big View notifications would be a preferred method of sending the notification, because they allow for the display of more information. However, Big View notifications were not enabled in devices until Android OS 4.1. As of this writing only 16.5% of Android OS devices fit into this category, meaning that if a Big View notification would fail on an older device. The notification handler component would understand this and send the appropriate notification. Further, Android, similar to apple has restrictions on how long a notification will display in the Status Bar. The notification handler would send tightly timed status notifications and updates to allow for constant display.

### Enhanced Intra-Company Caller ID Expanded to Mobile Devices

FIG. 10 is an example environment of an enhanced intra-company caller ID in accordance with some embodiments. In large organizations with many employees and thus many office phones, companies often utilize a shared external caller ID. For example, Big Company has 5,000 workers with one phone per worker. Big Company has one main toll free number (e.g. 800-555-5555 and several other toll free numbers that are displayed when a call is made from within Big Company to any phone outside of the company phone system. When a user dials outbound from an office phone to a mobile phone of someone within the company, the call will appear to person outside receiving the call as one of the toll free numbers without identifying who made the call. For example, Apple Computer might have several thousand employees that have the same outgoing phone number. This means that if John Doe of sales calls from inside the company to Sally Smith, Sally may have no idea that John Doe called her without listening to John Doe's voicemail that may or may not have been left. While this is solved by some companies through the issuance of Direct Inward Dial numbers to uniquely associate an extension to a user, these numbers can become costly to a company with so many employees.

This problem is solved by configuring the Phone System Monitor to sit on top of the company phone system and listen to outgoing calls. When an internal extension dials the mobile phone of a user authorized to receive extension information, the user will receive a notification indicating who from within the company is calling them.

An advantage of this approach is that up until now phone pop ups were only displayed within the company on company computers that were within the same office network. This solution sends notifications outside the company onto devices that are on a completely different network.

### Enhanced Outbound Caller Identification

FIG. 12 is a flow diagram of an example method to initiate an outbound phone call. In general, enhanced outbound caller identification may be used to allow a user to place an outbound phone call from a personal phone device while a receiving phone with caller identification functionality may display another phone number or identification. For example, a user may place a phone call from his or her personal phone (or computing device, mobile phone, etc.) and the receiving phone's caller ID functionality may display the user's business phone. Such an issue may be addressed by allowing a user to place an outbound phone call on his or her personal phone and originate the phone call from his or her office phone. For example, at step 1200, the user may initiate an outbound call. At step 1202, the application may transmit the outbound phone number to the backend information processor, which may look up the implementation details of the user's office phone system in a customer database. At step 1204, the backend information processor places an appropriate API call to the user's phone system to originate the outbound phone call from the user's phone system. Next, at step 1206, the phone system may be used to make a phone call to the user's phone and, at step 1208, the phone system may detect that the phone call was answered by the user. Subsequently, the phone system may place a phone call to the previously initiated outbound phone call and the phone system may bridge, at step 1210, the phone calls together. The result may be that the caller identification displayed to the recipient of the outbound phone call may be the phone number from the user's office phone system. At step 1212, the phone system may immediately bridge both calls.

### Business Contact Book

In some environments, a business contact book may be provided to a user based on the user's relevant contacts. For example, a business contact book for a corporation may comprise a large number of business contacts for various people in the corporation. However, only a subset of the total number of business contacts may be relevant for the user. As such, a relevant subset of the total number of business contacts may be provided to the user. In some embodiments, a contact relevance filter may be used to provide an optimal number of contacts in a business contact book that is personalized for the user. For example, the contact relevance filter may allow the user to select the maximum number of contacts to include in the user's personalized business contact book and/or a weighting system for which contacts may be included. Examples of weighting factors or criteria for the weighting system include, but are not limited to, any contact which has recently called, any contact which has an associated opportunity or quote, any contact which has been recently emailed, any contact that was recently created (e.g., recently added by the user or recently added to the corporation's business contact book), any contact with a task to call the user on a particular date, etc. Exclusion factors may also be used, such as excluding any contact that has a status of “Do Not Call” or “Retired” or any contact associated with an opportunity that was lost.

In some embodiments, an artificial intelligence algorithm may be used. An ideal filter could be automatically tailored to the user without requiring any configuration. Analysis could look at the various attributes of contacts when called. For example, the algorithm may search a CRM system over time for when Call Objects are logged in the CRM system. The algorithm may learn by detecting certain patterns found in the CRM system. A feedback loop to allow the user may also be used to look up phone numbers which aren't included in the “Business Contact Book” to assist in improving the accuracy of the artificial intelligence algorithm.

FIG. 11 is a flow diagram of an example method utilizing a local contacts database. In general, the method of FIG. 11 may be utilized without a network cloud database. As shown, the method of FIG. 11 may display, at step 114, a notification on a computing device such as a mobile phone. A user may launch, at step 200, an application and additional details associated with a caller of an incoming phone call may be retrieved at step 202. Furthermore, a contact book synchronization operation may be initiated at step 300, contacts may be retrieved from a CRM system, at step 302, by the backend information processor, and the relevance filter may be applied, at step 303, to filter the contacts retrieved from the CRM system to a subset of relevant contacts. Furthermore, a user may initiate, at step 304, an outbound phone call from the computing device and the contact associated with the outbound phone call (e.g., the contact associated with the phone number of the outbound phone call) may be searched for, at step 306, by the backend information processor. As such, information from a local contacts database may be received, details may be retrieved from a launched application, and a backend information processor may also search for information. This information may then be added, at step 308, to a local database. For example, a contact may be added to the database if the contact does not already exist in the database. As such, a local contacts database may be created at step 310 where the local contacts database may display the relevant contacts for a user.

### Audible Notification

In some embodiments, the systems and methods disclosed herein may be placed on top of a PBX system and may monitor monitors incoming and outgoing phone calls. The PBX system may identify office phones by a unique identifier (e.g., an extension number). Through the recognition of this extension number, a user may able to tell where an incoming phone call is coming from. For example, John Doe of a custom support department is responsible for answering inbound phone calls concerning support inquiries. He has been placed into the customer support queue. However, John was feeling sick and has left the office to work from home. He still wants to be able to answer important support phone calls if other people in the office are not able to, so he forwards his office phone to his personal mobile phone. When John receives a call after forwarding his office phone to his personal mobile phone, he may not know if the incoming phone call is a customer support call, a personal friend, or a telemarketer. Since the systems and methods disclosed herein are able to detect the inbound extension that a phone call has originated from (e.g., caller of the incoming phone call presses 2 for support), the backend information processor and/or relevance filter may providing an audible notification to John's personal mobile phone that he will immediately recognize as a support call. Another application of this audible notification may be for notification of a VIP Customer. The relevance filter may detect certain criteria in the CRM system and include a special audible notification or ring tone to provide an audible cue of the importance of this incoming phone call.

### Phone System Monitor Supplement

In some embodiments, the systems and methods for enhanced caller identification may be dependent on the phone systems or mobile phone operating system used by the computing device. In some embodiments, an enterprise phone systems (also referred to as PBX systems) may have an API for retrieving call event information. In this example, the phone system monitor may take the form of an application that is written specifically for that particular phone system. The phone system monitor may detect when inbound phone call events are started and stopped and reports this information to the backend information processor. One example of this is the PBX system Asterisk™ by Digium. Asterisk™ uses a protocol called the Asterisk™ Management Interface that is capable of reporting call events. Using the protocol's “dial” commands along, the phone system monitor may detect when a phone call is being made. The phone system monitor may open a persistent transmission control protocol (TCP) connection to the Asterisk™ phone system and the PBX Asterisk™ and phone call event information may be retrieved using the Asterisk™ Management Interface protocol.

However, if a corporation doesn't have such a phone system, then additional systems and methods may be used to detect incoming phone numbers. For example, certain mobile phone operating systems may provide the ability to programmatically access the caller ID number of an incoming phone call at the mobile phone. In this case, the user wouldn't require that their calls are routed through a supported phone system. The phone itself may have a specialized application running on it that detects phone calls and pushes this information to the backend information processor. An alternative embodiment may be based on the use of a “virtual phone number” such as Google Voice™. A user with this type of service could give out his or her virtual phone number. In these types of systems, you can configure the system to simultaneously call multiple phones simultaneously. As a result, the user could use this type of service to have calls ring through to their cell phone and also a special phone number which allows for phone call events to be detected.

FIG. 13 is a diagrammatic representation of a network 1300, including nodes for client computer systems 1302₁ through 1302_{N}, nodes for server computer systems 1304₁ through 1304_{N}, nodes for network infrastructure 1306₁ through 1306_{N}, any of which nodes may comprise a machine 1350 within which a set of instructions for causing the machine to perform any one of the techniques discussed above may be executed. The embodiment shown is purely exemplary, and might be implemented in the context of one or more of the figures herein.

Any node of the network 1300 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc.).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 1350 includes a processor 1308 (e.g. a processor core, a microprocessor, a computing device, etc.), a main memory 1310 and a static memory 1312, which communicate with each other via a bus 1314. The machine 1350 may further include a display unit 1316 that may comprise a touch-screen, or a liquid crystal display (LCD), or a light emitting diode (LED) display, or a cathode ray tube (CRT). As shown, the computer system 1350 also includes a human input/output (I/O) device 1318 (e.g., a keyboard, an alphanumeric keypad, etc.), a pointing device 1320 (e.g., a mouse, a touch screen, etc.), a drive unit 1322 (e.g. a disk drive unit, a CD/DVD drive, a tangible computer readable removable media drive, an SSD storage device, etc.), a signal generation device 1328 (e.g. a speaker, an audio output, etc.), and a network interface device 1330 (e.g. an Ethernet interface, a wired network interface, a wireless network interface, a propagated signal interface, etc.).

The drive unit 1322 includes a machine-readable medium 1324 on which is stored a set of instructions (i.e. software, firmware, middleware, etc.) 1326 embodying any one, or all, of the methodologies described above. The set of instructions 1326 is also shown to reside, completely or at least partially, within the main memory 1310 and/or within the processor 1308. The set of instructions 1326 may further be transmitted or received via the network interface device 1330 over the network bus 1314.

It is to be understood that embodiments of this disclosure may be used as, or to support, a set of instructions executed upon some form of processing core (such as the CPU of a computer) or otherwise implemented or realized upon or within a machine- or computer-readable medium. A machine-readable medium includes any mechanism for storing information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

What is claimed is:

1. A method to display caller information, the method comprising:
receiving, by a computing device, an incoming phone call;
identifying, by the computing device, a phone number associated with the incoming phone call;
searching a database based on the identified phone number;
receiving information associated with the identified phone number from the database; and
displaying a notification comprising the information in response to the incoming phone call.

2. The method of claim 1, wherein the database is an external database comprising at least one of a CRM system, social network, or an exchange server.

3. The method of claim 1, wherein the searching is performed by the computing device transmitting a search query to the database over a wireless network.

4. The method of claim 1, wherein the notification comprises notes taken by the user of the computing device and a previous email sent by a caller of the incoming phone call to a user of the computing device.

5. The method as set forth in claim 1, wherein the notification comprises an option to launch an application to display additional information associated with a caller of the incoming phone call.

6. The method of claim 5, wherein the computing device is a mobile phone, the application is a mobile application.

7. The method of claim 1, further comprising searching a second database based on the identified phone number, the displayed notification comprises information from the first database and the second database.

8. A non-transitory computer readable medium carrying one or more instructions to display caller information, wherein the one or more instructions, when executed by one or more processors, causes the one or more processors to perform the steps of:
receiving an incoming phone call;
identifying a phone number associated with the incoming phone call;
searching a database based on the identified phone number;
receiving information associated with the identified phone number from the database; and
displaying a notification comprising the information in response to the incoming phone call.

9. The non-transitory computer readable medium of claim 8, wherein the database is an external database comprising at least one of a CRM system, social network, or an exchange server.

10. The non-transitory computer readable medium of claim 8, wherein the searching is performed by the computing device transmitting a search query to the database over a wireless network.

11. The non-transitory computer readable medium of claim 8, wherein the notification comprises notes taken by the user of the computing device and a previous email sent by a caller of the incoming phone call to a user of the computing device.

12. The non-transitory computer readable medium of claim 8, wherein the notification comprises an option to launch an application to display additional information associated with a caller of the incoming phone call.

13. The non-transitory computer readable medium of claim 12, wherein the notification is displayed on a mobile phone, the application is a mobile application.

14. The non-transitory computer readable medium of claim 8, further comprising searching a second database based on the identified phone number, the displayed notification comprises information from the first database and the second database.

15. A system, comprising at least one processor and memory, to display information associated with a caller of an inbound phone call, the system comprising:
a module to receive the inbound phone call;
a module to identify a phone number associated with the inbound phone call;
a module to query a database for caller information associated with the inbound phone call, the query is based on the identified phone number;
a module to display a first notification comprising at least a portion of the caller information from the database;
a module to determine that the inbound phone call has been answered; and
a module to display a second notification comprising an option to launch an application in response to the determination that the inbound phone call has been answered.

16. The system of claim 15, wherein the first notification and the second notification are displayed on a mobile phone screen, the application comprises a mobile application.

17. The system of claim 15, wherein the displaying of the second notification replaces the display of the first notification.

18. The system of claim 15, the system further comprising:
a module to query a second database with at least part of the caller information from the database,
wherein the first notification and second notification comprises information from the database and the second database.

19. The system of claim 18, wherein the database and the second database are external sources separate from the system and the querying of the database and the second database is based on a transmission over a wireless network.

20. The system of claim 15, wherein the application comprises additional information from the database and a function to log notes associated with the caller of the inbound phone call that is to be displayed in response to a subsequent inbound phone call associated with the caller.
